(19) United States
(12) Patent Application Publication
(10) Pub. No.: US 2022/0007783 A1
(43) Pub. Date: Jan. 13, 2022

(54) OUTSOLE FOR SAFETY FOOTWEAR AND METHOD FOR MANUFACTURING SUCH AN OUTSOLE

(71) Applicant: Diadora S.P.A., Caerano di San Marco (TV) (IT)

(72) Inventor: Cristian Ardissono, Volpago del Montello (TV) (IT)

(21) Appl. No.: 17/299,509

(22) PCT Filed: Oct. 30, 2019
(86) PCT No.: PCT/EP2019/079633

§ 371 Date: Jun. 3, 2021

(30) Foreign Application Priority Data
Dec. 4, 2018 (IT) 102018000010789

(51) Int. Cl. A43B 13/12; A43B 7/08; A43B 7/32; B29D 35/12; B29D 35/14

(52) U.S. Cl. CPC A43B 13/125; A43B 7/088; B29D 35/142; B29D 35/122; A43B 7/32

(57) ABSTRACT

The present invention relates to an outsole (1) for safety footwear (10) comprising a top surface (2), designed to support the foot of the wearer, a bottom surface (4), designed to be in contact with the ground, and a side surface (6), designed to connect the top surface (2) and the bottom surface (4). The outsole (1) is further provided with an anti-perforation layer (8) and with at least one ventilation passage (12) designed to put into fluidic communication the side surface (6) and the top surface (2) of the outsole (1). According to the invention the outsole (1) is characterized in that the anti-perforation layer (8) is arranged between the bottom surface (4) and the at least one ventilation passage (12) at the heel portion of the outsole (1) and is arranged close to the top surface (2) at a forefoot portion of the outsole (1). The present invention also relates to a method for manufacturing such an outsole (1).

The present invention relates to an outsole for safety footwear. The present invention also relates to a method for manufacturing such an outsole.

Safety shoes and boots are widely used in many working environments, where their use is often mandatory for protecting the foot of the workers from punctures caused by sharp objects, impacts against obstacles and impacts caused by falling objects.

Usually, the employers provide a single pair of safety shoes to their workers and therefore a single person often uses the same pair of safety shoes all day, every day.

Therefore, it is important that the worker is provided with a shoe able to assure him an adequate level of safety without sacrificing the overall comfort of the shoe.

Flexibility and breathability are the most significant factors, which contribute to the comfort of the shoe.

Safety shoes provided with an anti-perforation layer integrated into the footwear are well known in the art.

The anti-perforation layer is designed for preventing or limiting injuries which may be caused when the worker accidentally stands on a nail or other sharp object. Anti-perforation layers can be made of different materials, and currently the textile based solutions are the most popular because they are lighter and more flexible. Usually these textile layers are attached to the bottom of the shoe upper, preferably manufactured by using the Strobel construction, so that they extend under the foot.

The textile anti-perforation layers have an extremely tight weave of threads in combination with non-woven materials. As a result, the anti-perforation layers have a thickness often greater than 4 mm and do not allow the air to pass through their structure. An example of a safety shoe provided with a textile anti-perforation layer is disclosed in U.S. Pat. No. 6,167,639B1.

A more breathable shoe is disclosed in US 2016/1057554 having as object an outsole provided with a tread layer and an air ventilating midsole. The outsole is also provided with an anti-perforation layer which is positioned between the bottom tread and the air ventilating midsole.

This solution allows an improvement in the breathability of the shoe, since the anti-perforation layer, being positioned underneath the air ventilating midsole, does not affect the breathability of the shoe.

However, this solution has at least two drawbacks. The first one is related to the outsole construction which envisages the various layers of the outsole (tread, anti-perforation layer, midsole) to be glued together. Such a disadvantage is more evident in the preferred embodiment of US 2016/1057554, wherein the anti-perforation layer is enclosed in a clear plastic covering.

As a matter of fact, many glue layers must be interposed between the various elements of the outsole for assembling it. For example, a first glue layer must be interposed between the tread and the bottom edge of the clear plastic covering, a second glue layer must be interposed between the bottom edge of the clear plastic covering and the anti-perforation layer, a third glue layer must be interposed between the anti-perforation layer and the top edge of the clear plastic covering, a fourth layer must be interposed between the top edge of the clear plastic covering and the midsole.

The above mentioned glue layers make the outsole more rigid and the various operations needed for assembling the sole more time consuming and thus costly.

Furthermore, in the solution disclosed in US2016/1057554 the anti-perforation layer is arranged distant from the top surface of the outsole, namely the surface designed to be in contact with the upper of the shoe. In particular, the anti-perforation layer is distant from the flexing point of the outsole in the forefoot area.

This specific arrangement does not affect the comfort of the outsole when the user is standing. However, when the user starts to walk, in order to follow the walking movement of the foot, the outsole should be able to correctly bend and, as consequence, the anti-perforation layer should be able to stretch, and the greater the distance from the flexing point, the greater the amount of stretch required.

However, the anti-perforation layer, being blocked between the tread and the midsole and due to its layered structure in this specific arrangement, can undergo a much reduced elongation. As a consequence the flexibility of the outsole is almost not existent.

The object of the present invention is to solve at least partially the problems mentioned in connection with safety outsoles, provided with an anti-perforation layer, of the known types. In particular, an aim of the present invention is to provide an outsole for safety footwear which is able to assure an improved ventilation of the user's foot without affecting the comfort of the outsole.

Moreover, an aim of the present invention is to provide an outsole for safety footwear which resists punctures and is of relatively light weight.

Furthermore, an aim of the present invention is to provide an outsole for safety footwear which is relatively easy to assemble.

Additionally an aim of the present invention is to provide a method for manufacturing such an outsole for safety footwear which may be easily implemented on an industrial scale.

These and other objects and aims are achieved by an outsole for safety footwear according to claim 1, a safety footwear according to claim 15 and by a method for producing such an outsole according to claim 16.

The characteristic features and further advantages of the invention will be clear from the description, provided herein below, of a number of examples of embodiment, provided by way of a non-limiting illustration, with reference to the attached drawings in which:

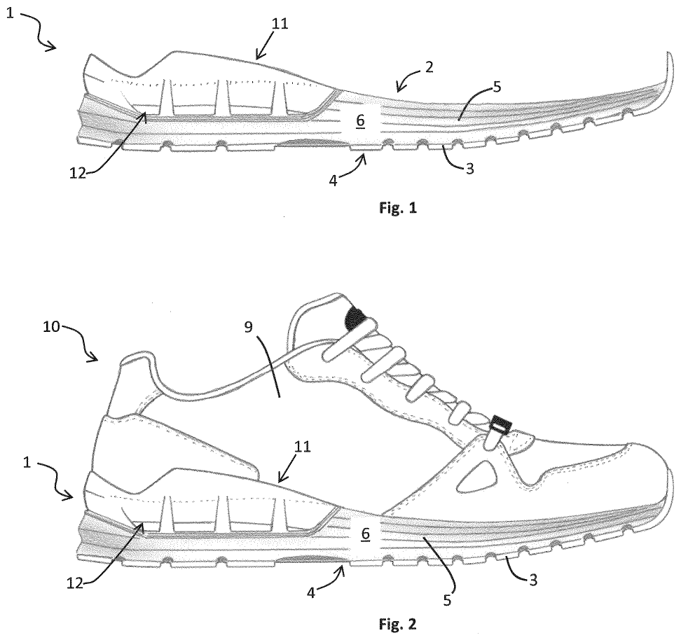

FIG. 1 shows a side view of an outsole according to the invention;

FIG. 2 shows a side view of a safety shoe provided with the outsole of FIG. 1;

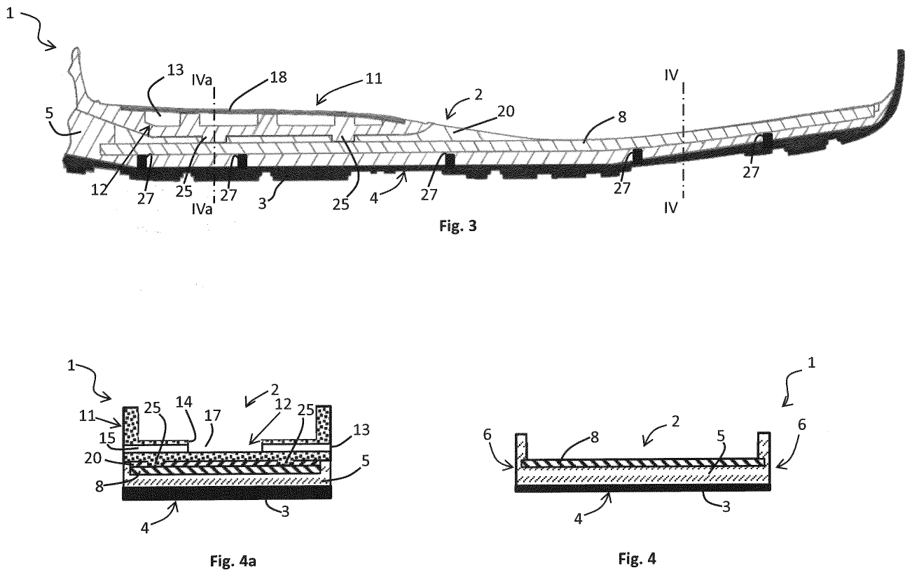

FIG. 3 shows a longitudinal cross-sectional view of the outsole of FIG. 1;

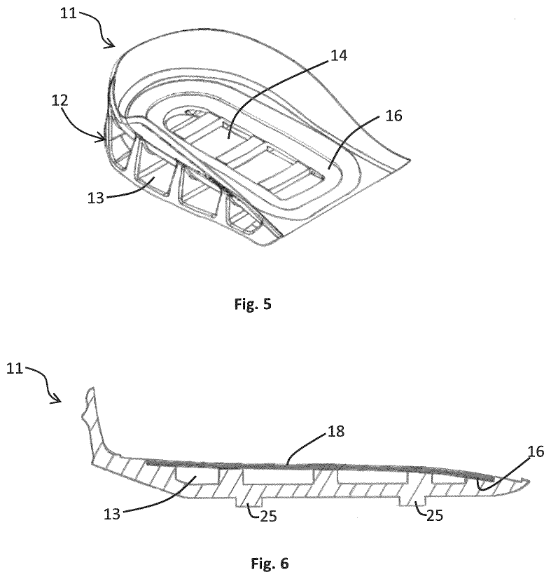

FIG. 4 shows a transverse cross-sectional view along the plane IV-IV of FIG. 3;

FIG. 4a shows a transverse cross-sectional view along the plane IVa-IVa of FIG. 3;

FIG. 5 shows a perspective view of a component of the outsole according to the invention;

FIG. 6 shows a longitudinal cross-sectional view of the component of FIG. 5;

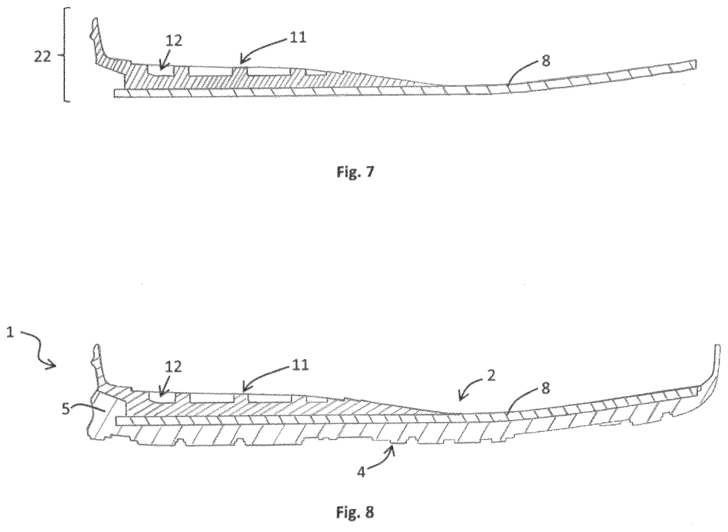

FIGS. 7-11 show schematic views of various steps of a method according to the invention.

With reference to the attached figures, an example of an outsole for safety footwear, according to the invention, is indicated in its whole by the reference number 1.

The description of the outsole 1 and its single components provided below relates to an outsole 1 which is used correctly.

In particular, in the following description, the term “front” will be used to identify the part of the outsole, or its single components, which is/are relatively closer to the toe of the foot, while “rear” will be used to indicate the part of the outsole, or its single components, which is/are relatively closer to the heel. Similarly, “top” will refer to the part of the outsole, or its single components, which is/are relatively more distant from the ground, while “bottom” will be used to indicate the part of the outsole, or its single components, which is/are relatively closer to the ground.

As shown in FIG. 2, the outsole 1 is designed to be joined to an upper 9 for obtaining a safety footwear 10.

The outsole 1 comprises a top surface 2, a bottom surface 4 and a side surface 6.

In detail, the top surface 2 is designed to support the foot of the wearer of the safety shoe 10, the bottom surface 4 is designed to be in contact with the ground and the side surface 6 is designed to connect the top surface 2 and the bottom surface 4. As side surface it should be intended thus both the inner and outer lateral surfaces of the outsole.

As shown in FIGS. 1-2, the outsole 1 is also provided with at least one ventilation passage 12 which is designed to put into fluidic communication the side surface 6 and the top surface 2, preferably at the heel portion, namely the rear portion, of the outsole 1.

Preferably the outsole 1 is provided with a plurality of ventilation passages 12. In the attached figures it is shown an embodiment of the outsole 1 with four ventilation passages 12. Obviously, different arrangements of the ventilation passages 12 are possible, in order to meet other specific needs.

Once the outsole 1 is joined to the upper 9, the ventilation passages 12 allow the ventilation of the bottom surface of the upper 9, usually consisting in an insole, and thus of the foot of the wearer.

The outsole 1 is also provided with an anti-perforation layer 8. Preferably the anti-perforation layer 8 has a surface area suitable for protecting the whole bottom part of the foot of the wearer from punctures caused by sharp objects.

According to the invention, the anti-perforation layer 8 is arranged between the bottom surface 4 and the ventilation passages 12 at the heel portion of the outsole 1 and is arranged close to the top surface 2 of the outsole 1 at a forefoot portion of the outsole 1, as shown in FIGS. 3, 4 and 4a.

In the following description, as “close to the top surface 2 at a forefoot portion of the outsole 1” it means that, at the forefoot portion of the outsole 1, namely the front part of the outsole 1, the top portion of the anti-perforation layer 8 is arranged not more than 3 mm from the top surface 2 of the outsole 1, even if it is embedded therein.

In particular, in case the outsole is provided with a separate tread positioned at the bottom surface 4, “close to the top surface 2 at a forefoot portion of the outsole 1” should be intended that the anti-perforation layer at the forefoot portion of the outsole is not in contact with the top surface of the outsole's tread.

As will become clear from the description below, the above mentioned arrangement of the anti-perforation layer 8 at the heel portion and at the forefoot portion of the outsole 1 from one side allows to obtain an outsole more flexible and from other side permits an increased circulation of air between the outsole 1 and the upper 9 of the safety shoe 10.

As a matter of fact, being positioned at the forefoot portion of the outsole 1 in close proximity to the top surface 2, the anti-perforation layer 8 is able to follow the walking movements of the wearer even if it does not undergo an elongation. In other words, the forefoot of the outsole 1, even if it is provided with an additional layer, can flex correctly without hindering the wearer.

As a matter of fact, the anti-perforation layer 8 is close to the flexing point of the outsole at the forefoot portion.

At the same time, the anti-perforation layer 8, being positioned below the ventilation passages 12 at the heel portion of the outsole 1, does not act as a barrier for the circulation of air between the side surface 6 and the top surface 2 of the outsole 1.

Advantageously, as schematically shown in the enclosed figures, at the forefoot portion of the outsole 1, the top portion of the anti-perforation layer 8 can coincide at least partially with the top surface 2 of the outsole 1. In other words, in this embodiment, the insole of the upper 9 lies directly on the anti-perforation layer 8.

With reference to FIGS. 3, 4 and 4a, the outsole 1 preferably comprises a tread 3 and a midsole 5, the tread 3 being positioned at the bottom surface 4 of the outsole 1 and the midsole 5 occupying the volume delimited by the top surface 2 and the side surface 6 of the outsole 1.

Preferably the tread 3 is made with styrene-butadiene-styrene rubber (SBS rubber) or styrene-butadiene-rubber (SBR rubber) or with thermoplastic polyurethane (TPU). The midsole 5 in turn is preferably made with polymer foam materials, for example expanded polyurethane (PU) or Ethylene-vinyl acetate (EVA).

Advantageously, bosses 27 can be provided between the top surface of the tread and the bottom surface of the anti-perforation layer 8.

Preferably, bosses 27 are provided at the rear and/or at the front part of the tread 3. Said bosses 27 are suitable for favoring the alignment of the tread 3 with the midsole 5 or with the other components of the outsole 1 during the assembly of the outsole 1.

Advantageously the bosses 27, positioned at the front part of the tread 3, are suitable to keep spaced apart, namely not in contact, the anti-perforation layer 8 and the top surface of the tread 3 at the forefoot portion of the outsole. Preferably, the bosses 27 project from the top surface of the tread, being integral with the tread.

In an outsole 1 provided with a tread 3 and a midsole 5, the ventilation passages 12 are preferably provided at the heel portion of the midsole 5.

Each ventilation passage 12 connects an opening 13 provided at the side surface 6 with an opening 14 provided at the top surface 2 (see FIG. 4a, wherein for clarity reason the additional layer 18, described below, has been removed).

Preferably, each ventilation passage 12 comprises a transverse channel 15 and a vertical channel 17. The transverse channel 15 connects opposite openings 13 provided at the side surface 6 of the outsole 1. The vertical channel 17, in turn, extends from the transverse channel 15 to the opening 14 of the top surface 2 of the outsole 1.

Advantageously, transverse channels 15 and vertical channels 17 intersect close to the top surface 2 of the outsole 1 and thus close to the bottom portion of the upper 9.

Preferably, the outsole 1 is made with a flexible material and thus the transverse channels 15 and the vertical channels 17 during the walking movement, under the pressure of the user's foot, are able to contract and to expand, so as to allow an improved circulation of air therein. Such circulation of air, as above mentioned, is not affected by the presence of the anti-perforation layer 8 inside the outsole 1 and permits to ventilate the user's foot.

Advantageously, as shown in FIGS. 3 and 6, the openings 14 provided at the top surface 2 of the outsole 1 can be covered by an additional protective layer 18.

Preferably, this additional protective layer 18 is made with a protective mesh material. Such a protective mesh material allows air to pass through and at the same time it prevents that small objects, which could penetrate inside the ventilation passages 12, can damage during the walking movement the bottom portion of the footwear upper 9.

Alternatively, the additional protective layer 18 can consist of a waterproof/breathable membrane. Such a membrane prevents infiltration of water inside the upper 9 of the shoe 10, through the ventilation passages 12 if, for example, the wearer stands in a puddle. At the same time the membrane being also breathable permits water vapor to pass through, so as to maintain the breathability offered by the ventilation passages 12.

In a further embodiment not shown in the attached figures, the additional protective layer 18 can comprise a protective mesh material and a waterproof/breathable membrane, the latter being preferably positioned on top of the protective mesh material.

According to an embodiment of the present invention, the outsole 1 comprises a heel insert 11, shown in FIGS. 1, 2, 3, 4a and 6, which is embodied as a separate element from the other parts of the outsole.

Alternatively, the heel insert 11 can be integral with the anti-perforation layer 8. In this case, the heel insert 11 is directly injected over the top surface of the anti-perforation layer 8 so as to obtain a single item.

In both cases, the heel insert 11 is designed for being positioned at the top surface 2 of the outsole 1 or of the midsole 5 and preferably it is anatomically shaped so as to encompass the heel of the wearer.

The top surface of the heel insert 11 is preferably designed to abut against the insole of the upper 9.

Advantageously, as it is clearly shown in FIG. 6, in case the heel insert 11 is separated from the anti-perforation layer 8, the bottom surface of the heel insert 11 can be provided with bosses 25, suitable for assisting the alignment of the heel insert 11 when it is mated with the other components of the outsole. Preferably, the bosses 25 are circular.

Preferably, the ventilation passages 12 of the outsole 1 are provided into the heel insert 11. In this case the openings 13 and 14 are thus provided at the side surfaces and at the top surface of the heel insert 11.

The heel insert 11 is preferably made with a polymer material which can be advantageously different from that of the remaining portion of the outsole 1 or of the midsole 5. Preferably the heel insert 11 is made with a more rigid material, for example nylon, polyurethane or thermoplastic polyurethane (TPU), than that of the remaining part of the outsole.

Also in this case, an improved breathability of the outsole is guaranteed. As a matter of fact, due to the fact that the heel insert 11 is more rigid, it is possible to arrange therein ventilation passages 12 having a greater cross section, without the risk that the heel and the ventilation channels collapse under the pressure of the foot.

As shown in FIGS. 5 and 6, the top portion of the heel insert 11 can be provided with a perimetric seat 16 for housing the additional protective layer 18.

As anticipated, the outsole 1 is provided with an anti-perforation layer 8.

Such an anti-perforation layer 8 is preferably formed from woven and non-woven textiles.

Preferably, the anti-perforation layer 8 is formed from synthetic or polymeric fibers such as polyaramid fibers.

Advantageously, the outsole 1 comprises a single anti-perforation layer 8 having shape and size substantially corresponding to the shape and size of the insole of the upper 9.

The anti-perforation layer 8 preferably has a thickness comprised between 2 and 5 mm.

In the embodiment wherein the outsole comprises a midsole, an heel insert and a separate tread, preferably the rear portion of the anti-perforation layer 8, namely the portion positioned between the bottom surface 4 and the ventilation passages 12, is interspaced between the heel insert 11 and the tread 3 so as to be fully embedded in the material of the midsole 5. In this way an improved cushioning effect at the heel portion of the outsole can be provided.

Preferably, at its rear portion, the anti-perforation layer 8 is provided with a spacer element 20, shown in FIGS. 3, 4a, 9 and 10. The spacer element 20 covers at least partially the top portion of the anti-perforation layer 8 and is designed to be in contact with the bottom portion of the heel insert 11.

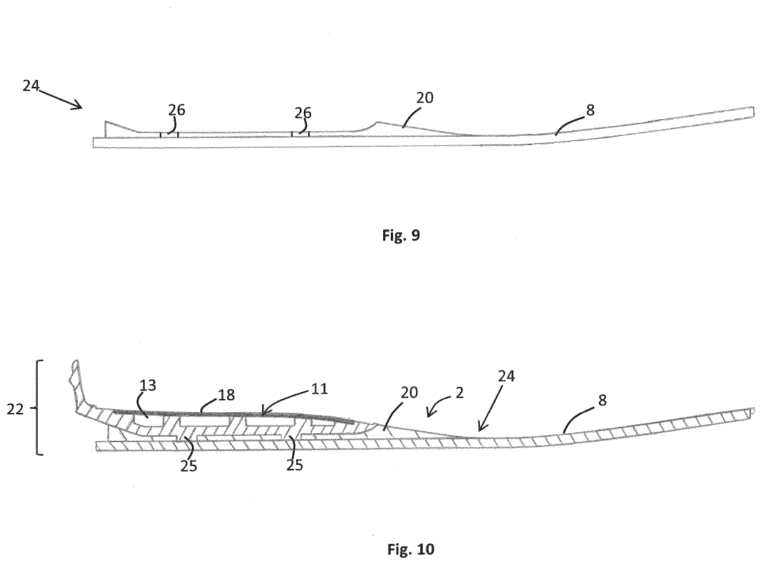

As it is clearly shown in FIG. 9, the spacer element 20 can be provided with cavities 26 which are designed to engage with the bosses 25 of the heel insert 11. Advantageously, the cavities 26 are suitable to assist the correct alignment of the spacer element 20 with the heel insert 11.

Alternatively, the upper surface of spacer element 20 can be provided with projections (not shown in the attached figures). Advantageously, in this case, the heel insert 11 will be provided at its bottom surface with corresponding cavities in order to assist the correct alignment of the spacer element 20 with the heel insert 11.

The thickness of the spacer element 20 corresponds to the set up distance between the anti-perforation layer 8 and the heel insert 11.

The spacer element 20 does not extend the full length of the anti-perforation layer 8, since according to the invention the front part of the anti-perforation layer 8 needs to be close to the top surface 2 of the outsole 1, to assure an improved flexibility to the outsole 1.

The spacer element 20 can be completely solid. Alternatively, the spacer element 20 can be hollow in the middle so as to cover only a perimetric portion of the anti-perforation layer 8. In a further embodiment, the spacer element 20 can be provided with further means in addition to the cavities 26, for example indents or notches, able to assist the alignment and the bonding of the spacer element 20 with the midsole 5 and the heel insert 11.

The top portion of the spacer element 20 can be properly shaped so as to help the positioning of the heel insert 11 on top of it (see FIG. 9).

As anticipated, the present invention also relates to a method for manufacturing the outsole 1.

This method makes reference to the embodiment of the outsole 1 wherein the ventilation passages 12 are provided in a heel insert 11.

The method comprises the following steps:
a first injection phase that includes the injection in a first mould of a polymer material over the rear part of an anti-perforation layer 8 for obtaining a first assembly 22 formed by the anti-perforation layer 8 and the heel insert 11 provided with ventilation passages 12 (see FIG. 7);
a second injection phase that includes the injection in a second mould of a polymer material at the bottom part of the first assembly 22 previously formed, and loaded in the second mould, so as to obtain the outsole 1, wherein the anti-perforation layer 8, at the heel portion of the outsole 1, is arranged between the bottom surface 4 and the ventilation passages 12 and, at the forefoot portion of the outsole, is arranged close to the top surface 2 (see FIG. 8).

The moulds used for the first and the second injection phases comprise a cavity and a lid and are not shown since they are of the known type.

The ventilation passages 12 represent undercut features which could prevent the first assembly 22 to be ejected from the first mould. Advantageously, the ventilation passages 12 can be obtained, in a known manner, by means of sliding inserts provided in the cavity or in the lid of the mould.

The polymer material of the first injection phase can be the same as the polymer material used in the second injection phase. Alternatively, two different polymer materials can be used. Preferably, the second injection phase is carried out by loading the second mould on the moulding machine in an upside down configuration, namely with the cavity on top of the lid. In this way, advantageously the first assembly 22 obtained during the first injection phase can be positioned inside the mould by putting it in direct contact with the lid, which acts as a base. In particular, by providing the base with alignment reference signs, it is possible to make easier the positioning of the anti-perforation layer 8 on the base. At the same time, by positioning the forefoot portion of the anti-perforation layer 8 in direct contact with the base, it is possible to block it so as to assure that the pressure exerted by the polymer material during the second injection phase does not displace the assembly 22 from its correct position. In a first embodiment of the present invention, the first injection phase can be carried out in two separate steps, which can be performed at the same time or in different moments.

In the first step, the anti-perforation layer 8 is loaded in a further mould for being over-injected in its rear portion with a polymer material so as to obtain a second assembly 24, formed by the anti-perforation layer 8 and the spacer element 20 (see FIG. 9).

In the second step the heel insert 11 is separately obtained by means of injection of polymer material in a different mould.

In this embodiment, therefore, the first assembly 22 is obtained by placing the heel insert 11 on top of the second assembly 24.

It is clear that in this embodiment the first assembly 22 is not a single element, being composed by two distinct elements, namely the heel insert 11 and the second assembly 24, formed in its turn by the spacer element 20 and the anti-perforation layer 8. The distinct elements of the first assembly 22 will be joined during the successively second injection phase.

Afterwards, the first assembly 22, namely the second assembly 24 and the heel insert 11, will be loaded into the second mould so as to perform the above mentioned second injection phase. Obviously, the heel insert 11 being not integral with the first assembly 22, can be loaded inside the mould as a separate insert.

Alternatively, in the second step the heel insert 11 can be injected directly onto the second assembly 24.

Preferably, as above mentioned, the spacer element 20 and the heel insert 11 can be provided with alignment features, namely the cavities 26 of the spacer element 20 and the bosses 25 of the heel insert 11, which favor the mutual positioning of the spacer element 20 and heel insert 11, during the assembling of the first assembly 22 (see FIGS. 9 and 10).

Preferably, also in this embodiment, the second injection phase is carried out by loading the second mould on the moulding machine in an upside down configuration, namely with the cavity on top of the lid which acts as a base.

In a different embodiment, inside the second mould together with the first assembly 22, a separate tread 3 can be loaded before performing the second injection phase.

In this embodiment, the first assembly 22 can be formed by the anti-perforation layer 8 and the heel insert 11, which are integral to each other, or by the second assembly 24 and the separate heel insert 11.

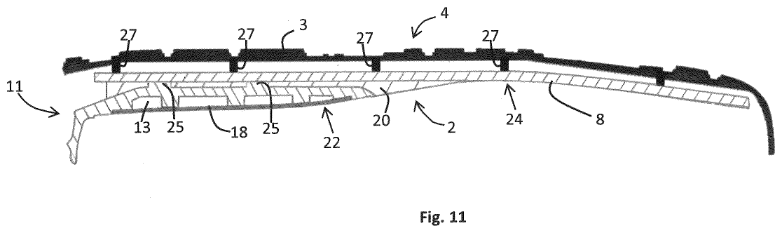

In particular, the first assembly 22 can be loaded on the cavity of the mould, while the tread 3 can be fixed to the lid. Also in this case, preferably the second mould is loaded on the moulding machine in an upside down configuration, namely with the cavity on top of the lid. In FIG. 11, which refers to the embodiment wherein the first assembly 22 is formed by the second assembly 24 and the separate heel insert 11, the mutual positioning between the tread 3 and the first assembly 22 is schematically shown.

Preferably, in this embodiment the tread 3 is provided at its upper portion with bosses 27 designed to abut against the bottom surface of the anti-perforation layer 8. Advantageously, the presence of bosses 27 on the upper portion of the tread 3 prevents the tread 3 lying directly on top of the anti-perforation layer 8, when the mould is loaded on the moulding machine in an upside down configuration, and thus creates a gap, between the tread 3 and the layer 8, into which the injected material can easily flow for assembling the various parts of the outsole. Without this feature there would be an increased risk that the injected material could flow onto the wrong side of the tread 3, namely over the bottom surface of the outsole, resulting in a production reject.

By carrying out the second injection phase as above mentioned, it is possible to obtain an outsole wherein the anti-perforation layer is embedded, at least at the rear part, in the middle of the midsole.

By means of the second injection it is thus possible to join the different parts (heel insert 11, spacer element 20, anti-perforation layer 8 and tread 3) of the outsole 1.

In a further embodiment, in case the outsole 1 is provided with a separate tread 3, the second injection phase can be carried in a second mould designed for allowing the direct injection of the polymer material over the upper 9 of the safety shoe 10 to which the outsole is to be affixed.

In this case, it is no longer needed to load the second mould on the moulding machine in an upside down configuration.

The second mould will be composed by a base, two side rings and a mould last. Such type of mould is not shown in the attached figures being well-known in the art.

The tread 3 and the first assembly 22 are loaded on the base. The first assembly 22 is positioned on top of the tread 3 which can be advantageously provided with bosses 27, projecting from the top surface of the tread 3 and suitable for favoring the mutual positioning between first assembly 22 and tread 3 and for keeping spaced apart, namely not in contact, the anti-perforation layer 8 and the top surface of the tread 3 at the forefoot portion. Moreover, the provision of the bosses 27 favors the flowing of the material inside the mould and between the tread 3 and the anti-perforation layer 8.

The two side rings are designed for abutting against the base, on which the tread and the first assembly 22 are loaded, and the mould last, on which is mounted the upper 9 of the shoe, so as to define a mould cavity wherein the polymeric material is injected.

The mutual positioning between the base and the mould last is performed so as to guarantee that the anti-perforation layer at the forefoot portion of the outsole is close to the bottom surface of the upper 9, mounted on the mould last.

In this way, it is possible to directly apply the outsole 1 to the safety shoe, without needing a further step.

At this point it is clear how the predefined objects may be achieved with the outsole 1 and the method according to the invention.

As a matter of fact, the outsole according to the present invention is provided with ventilation passages able to assure an improved ventilation of the wearer's foot without affecting the comfort of the outsole and the level of protection against punctures offered to the wearer.

Moreover, the arrangement of the anti-perforation layer inside the outsole as above mentioned does not affect the aesthetics of the outsole and the weight.

Furthermore, the method of the invention allows to obtain an outsole without needing to put a layer of glue between the various elements of the outsole. By means of the injection phases it is possible to simultaneously join all the outsole elements, for example the heel insert, the anti-perforation layer and the tread.

Moreover, the method according to the invention can be easily implemented since it uses common moulding techniques.

With regard to the embodiments of the outsole 1 and the method described above, the person skilled in the art may, in order to satisfy specific requirements, make modifications to and/or replace elements described with equivalent elements, without thereby departing from the scope of the accompanying claims.

1. An outsole for a safety footwear comprising a top surface, designed to support the foot of the wearer, a bottom surface, designed to be in contact with the ground, and a side surface, designed to connect the top surface and the bottom surface;
the outsole being further provided with an anti-perforation layer and with at least one ventilation passage designed to put into fluidic communication the side surface and the top surface of the outsole;
the outsole being characterized in that the anti-perforation layer is arranged between the bottom surface and the at least one ventilation passage at an heel portion of the outsole and is arranged close to the top surface at a forefoot portion of the outsole.

2. The outsole according to claim 1, characterized in that the at least one ventilation passage is designed to put into fluidic communication, at the heel portion of the outsole, the side surface and the top surface.

3. The outsole according to claim 1, characterized in that a top portion of the anti-perforation layer coincides at least partially with the top surface of the outsole at the forefoot portion of the outsole.

4. The outsole according to claim 1, further comprising a separate heel insert which is positioned at the top surface of the outsole;
said at the least one ventilation passage being provided into the heel insert.

5. The outsole according to claim 1, further comprising a heel insert which is integral with the anti-perforation layer;
said at the least one ventilation passage being provided into the heel insert.

6. The outsole according to claim 4, characterized in that the anti-perforation layer is provided with a spacer element covering at least partially the top portion of the anti-perforation layer;
the spacer element being designed to be in contact with the bottom portion of the heel insert.

7. The outsole according to claim 1, characterized in that the at least one ventilation passage connects a first opening, provided at the side surface of the outsole, with a second opening, provided at the top surface of the outsole.

8. The outsole according to claim 1, characterized in that said at least one ventilation passage comprises a transverse channel, connecting opposite openings, provided at the side surface of the outsole, and a vertical channel, extending from the transverse channel to an opening of the top surface of the outsole.

9. The outsole according to claim 8, characterized in that the transverse channel and the vertical channel of the at least one ventilation passage intersects close to the top surface of the outsole.

10. The outsole according to claim 1, further comprising a tread and a midsole;
the tread being positioned at the bottom surface of the outsole and the midsole occupying the volume delimited by the top surface and the side surface of the outsole.

11. The outsole according to claim 7, characterized in that the opening of said at least one ventilation channel is covered by an additional protective layer.

12. The outsole according to claim 11, characterized in that the additional protective layer is a protective mesh material or a waterproof/breathable membrane or a combination of both.

13. The outsole according to claim 1, characterized in that the anti-perforation layer is formed from woven and non-woven textiles.

14. The outsole according to claim 10, characterized in that bosses project from the top surface of the tread at the rear and/or at the front part of the tread;
the bosses, positioned at the front part of the tread, being suitable to keep the anti-perforation layer not in contact with the top surface of the tread at the forefoot portion of the outsole.

15. A safety footwear (10) comprising an outsole (1) according to claim 1.

16. A method for manufacturing an outsole for a safety footwear, the outsole comprising a top surface, designed to support the foot of the wearer, a bottom surface, designed to be in contact with the ground, and a side surface, designed to connect the top surface and the bottom surface;
the outsole being further provided with an anti-perforation layer and with an heel insert provided with at least one ventilation passage designed to put into fluidic communication the side surface and the top surface of the outsole at the heel portion of the outsole;
the anti-perforation layer being arranged between the bottom surface and the heel insert, at the heel portion of the outsole, and close to the top surface at the forefoot portion of the outsole, the method comprising the following steps:
a first injection phase that includes the injection in a first mould of a polymer material over the rear part of the anti-perforation layer for obtaining a first assembly formed by the anti-perforation layer and the heel insert;
a second injection phase that includes the injection in a second mould of a polymer material at the bottom part of the first assembly previously formed and loaded inside the second mould so as to obtain the outsole.

17. The method according to claim 16, characterized in that the first injection phase is carried out in two different steps;
in the first step, the anti-perforation layer is loaded in a further mould for being over-injected in its rear portion with a polymer material so as to obtain a second assembly, formed by the anti-perforation layer and a spacer element, and in the second step the heel insert is separately obtained by means of injection of polymer material in a different mould;
the first assembly being formed by the combination of the anti-perforation layer with the spacer element and the heel insert.

18. The method according to claim 17, characterized in that the spacer element is provided with cavities or projections which are designed to match corresponding bosses or cavities provided at the bottom surface of the heel insert, thereby favouring the mutual positioning of the spacer element and heel insert during the assembling of the first assembly.

19. The method according to claim 17, characterized in that the spacer element is shaped with curved edges able to match the underside curved edges of the heel insert thereby favoring the mutual positioning of the spacer element and heel insert during the assembling of the first assembly.

20. The method according to claim 16, characterized in that, before performing the second injection phase, a separate tread is loaded inside the second mould, together with the first assembly.

21. The method according to claim 20, characterized in that the tread is provided at its upper portion with bosses designed to abut against the bottom surface of the anti-perforation layer so as to create a gap between the tread and the anti-perforation layer into which the polymer material injected in the second injection phase flows during the assembling of the various parts of the outsole.

22. The method according to claim 16, characterized in that the first mould and the second mould comprise a cavity and a lid; the first injection phase and/or the second injection phase being carried out by loading the first mould and/or the second mould on a moulding machine in an upside down configuration with the cavity on top of the lid which acts as a base.

23. The method according to claim 20, characterized in that the second injection phase is carried out in a second mould designed for allowing the direct injection of the polymer material over an upper of a safety shoe.
